(19) United States
(12) Patent Application Publication
(10) Pub. No.: US 2008/0162518 A1
(43) Pub. Date: Jul. 3, 2008

(54) DATA AGGREGATION AND GROOMING IN MULTIPLE GEO-LOCATIONS

(75) Inventors: Gregg J. Bollinger, Columbia City, IN (US); Derek W. Botti, Holly Springs, NC (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 11/619,315

(22) Filed: Jan. 3, 2007

(51) Int. Cl. G06F 17/30

(52) U.S. Cl. 707/101; 707/E17.044

(57) ABSTRACT

The aggregation of data from multiple database sites, and the grooming of database after extraction are conducted in a bidirectional process. Using one-way replication, data is aggregated from multiple geo-locations into subscription sets. The aggregate is then mined and the mined data is extracted for analysis, further use, or storage. The aggregated data is then cleaned or groomed to delete the extracted data, and the cleaned data is returned to the geo-locations using a second one-way replication subscription set that replicates the data deletion to the target geo-location. The invention is particularly applicable to transient data that does not require continued storage after extraction.

### FIELD OF THE INVENTION

The present invention relates to collecting digitized data from a variety of sources, replicating the data into a single aggregation for mining, extracting the mined data, and thereafter deleting the mined data. In particular, it relates to the aggregation of data that is transient in nature, to the grooming of the extracted data as aggregated after extraction and deleting the data at the sources.

### BACKGROUND OF THE INVENTION

The information network commonly known as the Internet is perhaps the most comprehensive source of information available. Much of this information can be accessed (or extracted) by anyone who has a computer having Internet capabilities. However, being able to navigate through the maze of information pages (referred to as Web pages) to extract information can be a formidable task.

There are also numerous databases that are available only within a closed or restricted network. These databases often include proprietary information and may be accessed on a subscription basis, or may only be available to some or all of the employees of a company or members of a given organization. Various levels of security are often used to protect such databases from unauthorized access.

Traditional methods for the copying of data from multiple sources and for gathering data utilize technologies such as SQL replication. This involves copying and distributing data and database objects from one database to another, and synchronizing between databases to maintain consistency. It permits data to be distributed to different locations and to remote or mobile users over local area networks (LAN) and wide area networks (WAN), virtual private networks (VPN), dial up connections, wireless connections and the Internet. However, such programs have several shortcomings and do not readily lend themselves to aggregation and grooming of transient data. For example, extraction from a single RDBMS (relational database management system) produces a single file. Also, an atomic transaction can span multiple data locations. Accordingly, to capture all of the required data, aggregation must occur. Because the prior art does not involve a separate aggregation, or collection of data from multiple geographical locations in a multi-site environment, an additional processing step would be required to produce a single extract from multiple files. However, the addition of such a process to the extraction routine can produce unexpected and undesirable results that could cause data integrity issues, such as (a) failed transfers of data, resulting in missing or incomplete records, thereby possibly resulting in discarded entries or (b) aggregation mistakes which could result in the duplication of data sets.

Furthermore, there is a need to groom or cull transient or temporary data periodically, recognizing that disk storage space is not infinite, and database performance will suffer over time as the total storage of data continues to grow.

Accordingly, there exists a need in the art to deal with the deficiencies, limitations and shortcomings of existing aggregation systems including those described hereinabove.

### BRIEF DESCRIPTION OF THE INVENTION

These and other deficiencies in data collection and aggregation are overcome in accordance with the present invention which provides a bilateral solution to the collection and replication of data from multiple sources, and returning the data after use to the sources for grooming. The invention involves leveraged DB2 replication, meaning that no new software work product is required. Instead, it uses existing technology and does not involve the use of any proprietary code.

The invention has particular applicability to data that has value until it is aggregated and mined, after which there is no further need for the data. It relates to a software system for collecting data from a plurality of discrete geo-location hosting environments. The system comprises replicating the discrete data from the hosting environments into a single aggregate. The desired data is then mined from the aggregate. After mining, the extracted data is cleaned from the aggregate, and the various geo locations are then instructed by the aggregator to likewise perform the cleaning step to remove the extracted data from their databases.

The invention also relates to a method for using a DB2 system for aggregation, extraction and then removing the extracted data located in multiple geo-locations using an SQL delete statement.

The invention also relates to a data management system for aggregating data from multiple geo-locations, mining the aggregated data, returning the mined data to its respective geo-location, and grooming the data at each geo-location to correspond to the data that was mined

The invention also relates to a computer program embodied in or on a computer-readable medium or carrier, such as a floppy disk or a CD-ROM. The program includes instructions which, when read and executed by the computer processor, will cause it to perform the steps necessary to execute the steps of aggregation of data from multiple sources, the synchronized extraction of the data, the grooming of the extracted data from the aggregate, and the deletion of same data on a geo-location basis.

The invention likewise relates to a business method for deploying an application for data aggregation, extraction of selected data from the aggregate, and grooming in multiple geo-locations.

### BRIEF DESCRIPTION OF DRAWINGS

The drawings as described herein are merely schematic representations, are presented for the purpose of illustrating the invention and its environment, and are not intended to serve as a limitation on the invention.

FIG. 1 shows the database replication to a central collector from multiple geo-locations;

FIG. 2 shows the extraction to a disc of the database that has been collected in accordance with FIG. 1, and the return of data to each geo-location from which the data was replicated;

FIG. 3 shows the processes of extraction of data from the aggregator, and the two way processes of aggregation and cleaning;

FIG. 4 is a block diagram showing implementation of the invention; and

FIG. 5 is a flow diagram of the operative steps of the present invention.

These drawings are not intended to portray specific parameters of the invention.

### DETAILED DESCRIPTION OF THE INVENTION

The present invention relates to the aggregation of digitized data from a variety of database sites (hereafter referred to as geo-locations). Each database site is a machine that gathers data from any number of sources and makes the data available in response to specific requests. Each database site utilizes a collector to collect data from the site and to forward it to the aggregator. Collectors are well known in the art. Each collector represents a computer node comprising hardware or software that performs this function. It may include caches and/or buffers as required. It typically is located at, and is associated with a specific database site, but can be a stand-alone device with its own router and switch. The database sites may be at the same geo-locations, or at diverse locations. The sites are joined to the aggregator in parallel through a WAN connection so that each site acts completely independently of every other site.

In accordance with the present invention, an aggregator collects specific data from one or more geo-locations, and mines the aggregated data. The mined data is then extracted and is accumulated for further use. The data at the aggregator is then groomed or pruned to remove the extracted data. The respective geo-locations are then commanded to likewise clean or groom the extracted data from their database.

Turning now to the drawings, FIG. 1 shows a multiplicity of database sites 10, 12 and 14. Data is transmitted or replicated along routes 16, 18 and 20 to a central database aggregator 24. This aggregator 24 can be in the same geo or physical location as one or more of the database sites. Alternatively, the aggregator 24 can be at a different location, such as a different floor of a building, or a different building, or at a totally remote site, such as another location or state or country. Each geo-location creates a one-way replication subscription set to the aggregator database. There is no need for any of the geo-locations to be aware of the other geo-locations, although such awareness is not precluded.

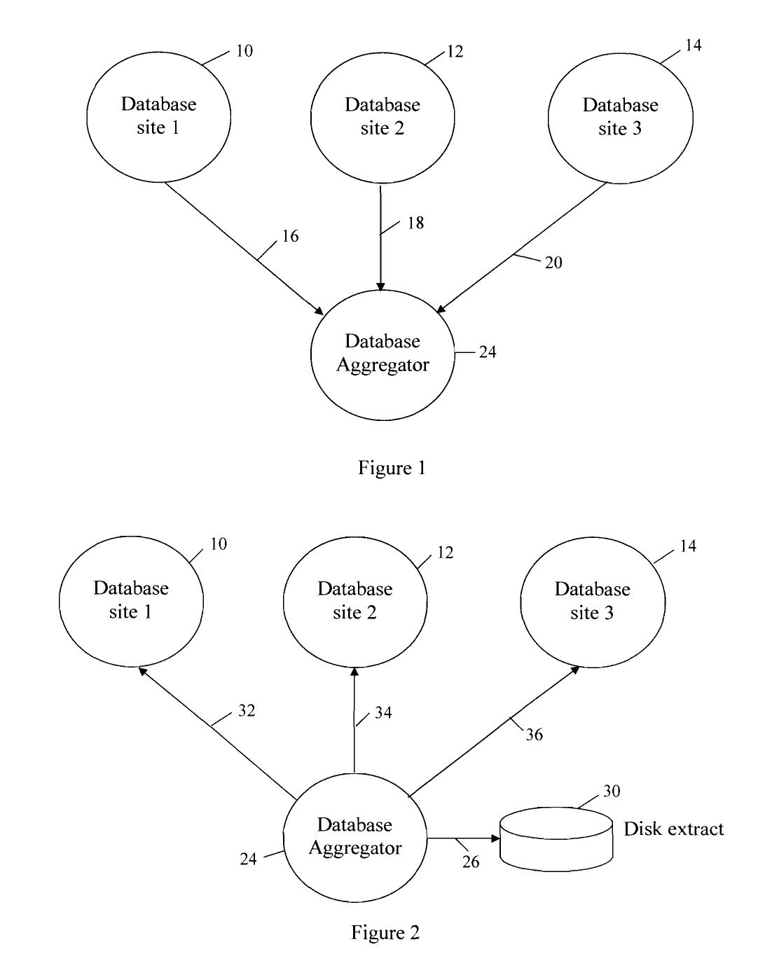

Turning next to FIG. 2, the data is mined and the extracted records are exported along bus 26 from the aggregator 24 to a disk extract 30 or other destination for further use, analysis or storage. Typically, these steps are achieved using a DB2 which is a database management system available from IBM Corporation. After the records are extracted, the same data is deleted from the database in the aggregator. It is to be understood that the present invention can be carried out using generic or custom mining and extracting processors other than the IBM DB2 processing system. After extraction, the database aggregator deletes the extracted data, and sends commands back along lines 32, 34 and 36 to database sites #1 (10), #2 (12) and #3 (14). Bilateral lines may be used both to transmit the data from the database sites to the aggregator and to send the commands back to the sites. Alternatively, separate lines may be used for these dual purposes.

This cleaning or pruning of data inside the database management system can be carried out by using a ‘drop’ which tells the system to no longer maintain the data structures. The entire structure is then deallocated. This type of pruning is instantaneous and complete. However, a preferred approach is to use a traditional SQL delete statement. SQLs are issued that specify which data elements within the structure are suitable for removal. This has the advantage that if the data structure has data elements that are not eligible for removal, only those rows of eligible data will be removed, rather than the entire data structure.

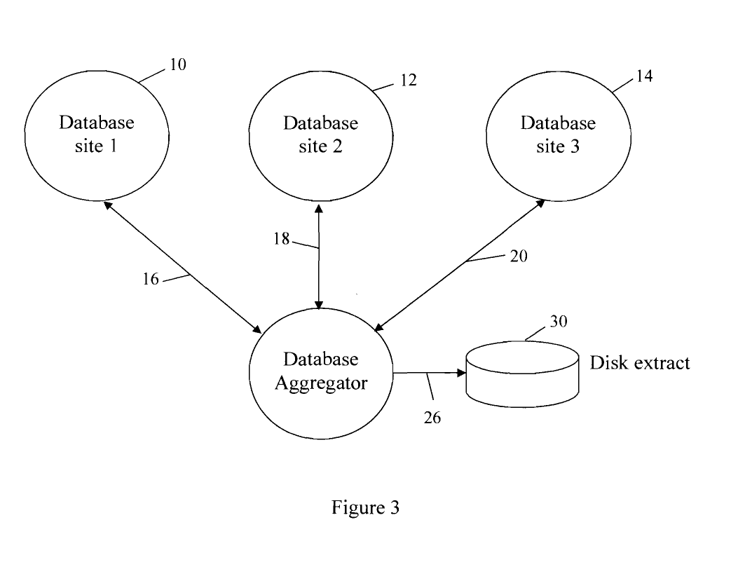

FIG. 3 shows the two one-way processes of aggregation and cleaning. The data is sent from database sites #1, #2 and #3 (10, 12, and 14) along lines 16, 18 and 20 to the aggregator to create the central storage. Data extraction is performed at the aggregator 24 and is forwarded along bus 26 to the disk extractor 30. The aggregator then removes the data from the production tables once the mining process is complete using SQL delete statements. This triggers the subscription sets (database sites #1, #2 and #3) to perform the equivalent delete in production.

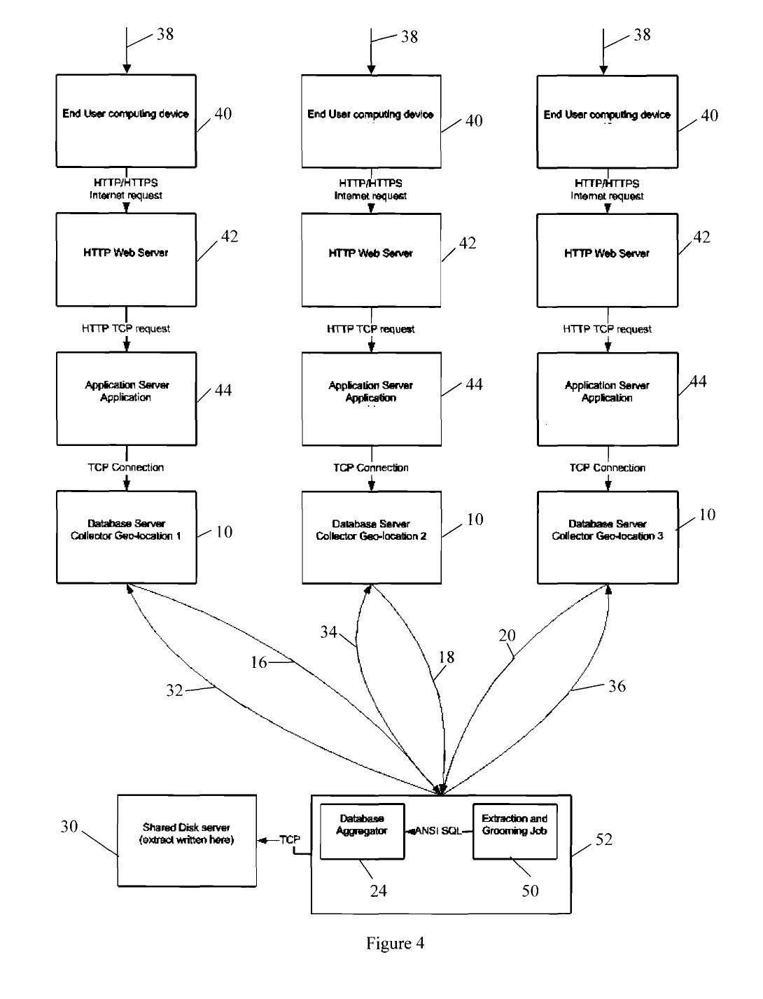

Looking next at FIG. 4, a typical block diagram is shown with an array of hardware and software components that are useful in performing the operative steps of the present invention. The diagram shows three parallel database streams, each of which communicates with a common database aggregator. Each stream begins with input 38 to an end user computing device 40 from a response, for example, to an on-line survey. The response to the internet requests travels by a secure or unsecure transmission control protocol (TCP) to a web server 42 such as one marketed by Microsoft, IBM, Sun, Dell or Netscape, or an open server such as an Apache Tomcat. The data is forwarded to an application server 44 pursuant to an HTTP TCP request. This application server 44 can be an IBM WebSphere, a server from Oracle or other similar device. From there, the data is sent to a geo-location database site 10, 12 or 14 which collects all of the information for further processing. Each site or geo-location includes a physical server such as an IBM server having a host name of at0201a, dt0201a or gt0201a. Each server comprises an RS/6000 P615 1.2 GHZ two-way server having 16 GB RAM and 260 GB Disc memory. It uses an AIX 5.2 or equivalent operating system and a DB2 V8.2 FPS application system. From each of the geo locations 10, 12 and 14, the data is forwarded to the aggregator 24 over a VPN using a program such as a DB2 TCP connection. The aggregator 24 is embedded in a server such as an IBM at0501a database server which also includes a program 50 to extract and groom the data on the aggregator. The at0501a is configured the same as the servers at the geo-locations, but with four GB of RAM instead of 16 GB. The extracted data is written using an SCSI or other TCP interface to a shared disc server 30 such as an IBM Shark or an EMC storage or other compatible device. Upon completion of the extraction, the database server grooms the aggregator to remove the extracted data. The database server then writes the extraction by the DB2 TCP program over a VPN 32, 34 or 36 to each of the respective geo-locations 10, 12 and 14.

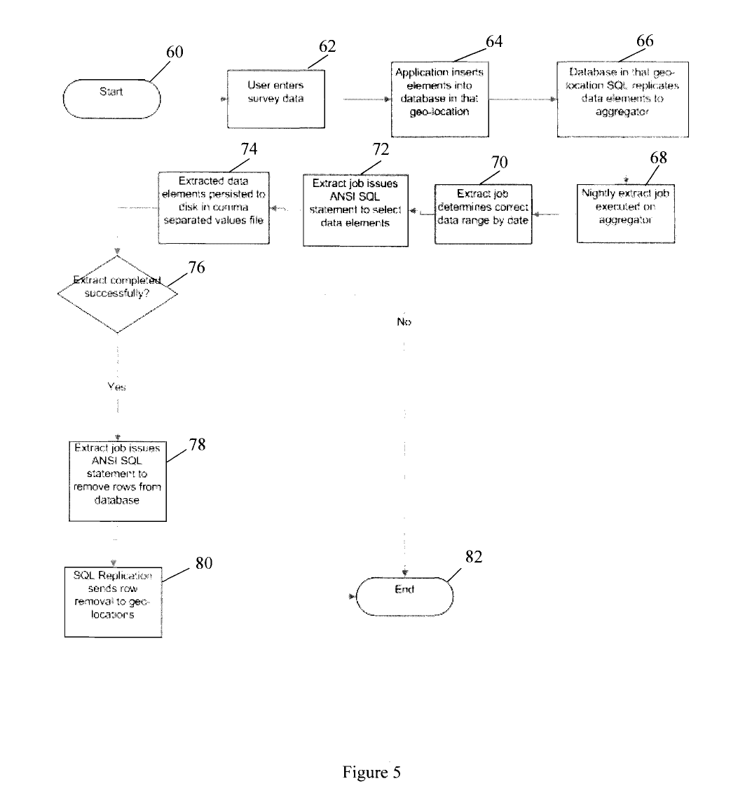

Turning now to FIG. 5, the various steps of the invention as depicted in the block diagram of FIG. 4 are shown in a flowsheet. The procedure is implemented at box 60, for example, by a user logging on to a web page or other internet site containing a user survey form. As the user enters the data into the survey form at step 62, the data is transferred at 64 to one of the database sites where a Java enterprise application server, such as IBM WebSphere AS, inserts the survey elements into a DB2 or other database management system at the respective database site. Other Java enterprise application servers such as Oracle Web application server or BEA Web Logic can be used in place of the WebSphere AS. The database management system at that location then replicates the collected data to the aggregator at step 66. This is done either automatically, or upon receiving a prompt from the aggregator or from another command center with instructions to download the information to the aggregator. In the meantime, it is stored at the database site until replication occurs.

The next step shown at step 68 is an extraction wherein selected data is mined from the aggregator 24 and is extracted to disc or other suitable memory device. The data can be extracted on a regular basis such as nightly, or upon being prompted on an as-needed basis. This is followed at steps 70 and 72 by a structured query in the form of an ANSI SQL to establish that all of the extracted data meets the data range criteria that has been requested. For example, the data can be examined to determine that the data was all collected during a given 24 hour time period. Step 74 stores the extracted data elements using a consistent format in a memory disc, as files that are separated from one another by delimiting characters such as commas or other punctuation that that is known to the user.

If the extract is shown as being completed at 76, another ANSI SQL is issued at 78 to remove the extracted data at the aggregator. This step is followed at 80 by a DB2 SQL statement to replicate the same data removal at the geo-locations where the data was originally stored. Upon completion of the DB2 SQL replication at the specific database sites, the entire process is completed at 82. If, however, at step 78, the extraction step for some reason is not successful, a purge of the extraction at the aggregator cannot occur, and the process terminates at 82. An intervention, either manually or electronically, is then used to determine why the extraction failed. Until the failure is rectified, the data will not be deleted from the aggregator or the database sites until the extraction step is completed successfully.

An example that shows the use of the present invention is the collection of survey data from a specific region of the United States, covering eight states (eight separate geo-locations). Each state might have between 10 and 100 outlets which conduct the survey among its customers, clients or patients. Among the information that is collected might be the approximate age of the persons being surveyed. All of the information data in each geo-location is collected at one central database site. For simplification, suppose that database site #1 has data elements 1-10, database site #2 has elements 11-20 and so forth. The aggregator can then poll each of the eight database sites asking for information obtained from surveyed persons between the age of 21 and 35. All relevant data covering surveys of this age group is collected in the aggregator. From here, the relevant data is extracted or mined and is recorded on disc or other memory device. Again, to facilitate understanding, suppose that this data is contained in the odd rows 1, 3, 5, 7, 9 of data at database site #1 and odd rows 11, 13, 15, 17, 19 in database site #2 and so forth. Following the extraction, the aggregator proceeds to clean or purge all of the extracted information from its data bank. As previously noted, this data is contained in the odd rows 1, 3, 5, etc. Because the host sites no longer have any need for these rows of data, aggregator sends an SQL query to each of the database sites 1-8 instructing them to remove all of these odd rows of data. In other words, when these rows are deleted in the aggregator, the configuration inside the aggregator alerts the various database sites so that they can likewise perform the same steps and delete these odd rows. Because the data at each of the sites has a finite shelf life, e.g. 24 hours, the removal of the data from the sites does not have any adverse effect on the usefulness of the database retention at the site.

While the invention has been described in combination with specific embodiments thereof, there are many alternatives, modifications, and variations that are likewise deemed to be within the scope thereof. While preferred embodiments of the invention have been described herein, variations may be made, and such variations may be apparent to those skilled in the art of computer functions, systems and methods, as well as to those skilled in other arts. The present invention is by no means limited to the specific programming language and exemplary programming commands illustrated above, and other software and hardware implementations will be readily apparent to one skilled in the art. The scope of the invention, therefore, is only to be limited by the following claims. Accordingly, the invention is intended to embrace all such alternatives, modifications and variations as fall within the spirit and scope of the appended claims.

What is claimed is:

1. A software system for gathering transient data from a plurality of discrete geo-location hosting environments, and for mining the data, comprising:
a) replicating data from the discrete hosting environments into a single aggregate;
b) mining specific data from the aggregate, and extracting the data to memory;
c) cleaning the mined data from the aggregate; and
e) replicating the cleaning step to the geo-locations, thereby removing the mined data at each geo-location.

2. The system according to claim 1 wherein the data is collected from the hosting environments either simultaneously or sequentially using either synchronous or asynchronous collection.

3. The system according to claim 1 wherein database management is provided by the use of a management program.

4. The system according to claim 1 wherein the data is cleaned from the mined aggregate using an SQL delete statement.

5. The system according to claim 4 wherein the data is cleaned from the hosting environment database sites using an SQL delete statement.

6. A method for mining and extraction of transient data from a plurality of discrete hosting environments and grooming of the mined data after extraction, comprising the steps of:
a) gathering data from databases in the hosting environments;
b) replicating the data into a single aggregate;
b) mining the data from the aggregate and transferring the mined data to memory;
c) cleaning the mined data from the aggregate; and
d) replicating the cleaning step at each of the hosting environments from which the data was transferred.

7. The method according to claim 6 wherein the replication of the data into a single aggregate is performed with the use of a management system.

8. The method according to claim 7 wherein the step of replicating the data from the discrete hosting environments into a single aggregate and the replicating of the cleaning step are performed using SQL replication.

9. The method according to claim 6 wherein the data is collected either simultaneously or sequentially using either synchronous or asynchronous collection from multiple hosts.

10. A method for deploying an application for the aggregation of data from plural discrete database sites, the mining of the aggregated data, the extraction of selected data from the aggregate, the grooming of the aggregated data to remove the extracted data therefrom, and the deleting of the data from the aggregate and from the plural database sites.

11. The method of deployment as specified in claim 10 wherein the replication of the data into a single aggregate is performed with the use of a management system.

12. The method of deployment according to claim 11 wherein the step of replicating the data from the discrete database sites into a single aggregate and the replicating of the cleaning step are performed using SQL replication.

13. The method according to claim 10 wherein the data is collected simultaneously from said plural discrete database sites.

14. The method according to claim 13 wherein the data is collected using synchronous collection.

15. The method according to claim 10 wherein the data is collected from said plural database sites using asynchronous collection.

16. The method according to claim 10 wherein the data is collected using sequential collection from the multiple hosts.

17. The method according to claim 16 wherein the data is collected using synchronous collection

18. The method according to claim 17 wherein the data is collected using asynchronous collection.

19. The method of deployment according to claim 10 wherein the data is collected into subscription sets.
